(19) United States
(12) Patent Application Publication
(10) Pub. No.: US 2003/0069990 A1
(43) Pub. Date: Apr. 10, 2003

(54) Router discovery protocol on a mobile internet protocol based network

(76) Inventors: Michael A. D'Annunzio, Redmond, WA (US); Vincent D. Skahan JR., Federal Way, WA (US)

Correspondence Address: HARNESS, DICKEY & PIERCE, P.L.C., P.O. BOX 828, BLOOMFIELD HILLS, MI, 48303, US

(21) Appl. No.: 09/972,125

(22) Filed: Oct. 5, 2001

(51) Int. Cl. G06F 15/173

(52) U.S. Cl. 709/242; 714/4

(57) ABSTRACT

A network operating the Internet Control Message Protocol (ICMP) Router Discovery Protocol (IRDP) on an Internet protocol (IP) based network on a mobile platform which supports automatic failover of the network's default router to one or more onboard back-up routers. A security safeguard is also implemented by including packet filters at each one of a plurality of seat electronics box (SEB) stations on the mobile platform which allows ICMP Type 9 and Type 10 packets transmitted on the network to be blocked. The filters further allow each SEB to accept only advertisements from pre-designated addresses of routers operating on the network.

### FIELD OF THE INVENTION

The present invention relates to Internet protocol (IP) based networks, and more particularly to a router discovery protocol implemented on a mobile IP-based network which allows a host operating on the network to recognize a back-up router as a default router in the event a predetermined default router should fail. The invention is also directed to a security measure for ensuring that the host only recognizes routers which have been preauthorized to operate on the IP-based network as possible back-up routers.

### BACKGROUND OF THE INVENTION

Internet Control Message Protocol (ICMP) Router Discovery Protocol (IRDP) is an ICMP-based protocol that allows hosts to discover default routers on locally attached networks. This protocol eliminates the need to manually configure a default route on each host operating on the network. If a “default” router on the network fails, the host(s) automatically selects a back-up router and adjusts its/their default routes accordingly. IRDP daemons running on non-routing hosts manipulate only default routes in the host's routing table.

IRDP defines two types of network devices: routers and hosts. IRDP provides two extended ICMP message types: advertisements and solicitations. A router advertises its network address and a receiving host enters the router's address in its routing table to create default IP packet routes. Each router on the network sends “advertisements” at regular time intervals (e.g., 60 seconds). A host can request an immediate advertisement by sending a solicitation over the network. IRDP advertisements are considered valid only for a predefined lifetime (typically 180 seconds). If a new advertisement is not seen during this lifetime, the router address is considered invalid and the host (or hosts) removes the corresponding default route from its routing table. The lifetime value is included in the header of every IRDP advertisement and applies to all addresses included in the IP packet.

Each router address further has a preference value associated with it. This value represents a signed 32-bit quantity. The IRDP hosts use the address with the highest preference value to determine which router is to be designated as the “default” router. Routers provide a mechanism to configure this preference value, although it will usually default to “0” if it is not configured to some other value.

In a mobile, Internet protocol (IP) based network having a host and a plurality of routers, it is important to be able to route IP packets transmitted by the host off of the mobile platform to a ground station or to some other off-platform destination in the event that the router which is designated as a “default” router fails. In such an event, if there was no means for allowing the host to reconfigure its routing tables to recognize a different router on the network as the default router, then no data packets could be transmitted from the host over the network if the default router fails. Therefore, it is important to have some mechanism by which the default router setting in the host (or the computing device interfaced to the host) could be changed to designate a different router on the network which was not previously designated as the default router. Such a feature would enable a different router besides the initial default router to be used to route IP packets off of the mobile platform in the event of a failure of the initial default router.

Another concern with the application of the IRDP on a mobile platform IP-based network is the risk of an unauthorized router gaining access to the network and advertising itself as the “most preferred” router, and then capturing any IP traffic from the host on the network. This risk exists because the IRDP makes no provisions for verifying the authenticity of advertisements transmitted by routers operating in accordance with the IRDP. Thus, with direct access to the network, any individual could set up a router advertising itself as the most preferred router and then capture any traffic from the host transmitted on the network. Such a scenario would also permit the machine to be used to perform “man-in-the-middle” style attacks.

In view of the foregoing, there also needs to be some mechanism of a network incorporated on a mobile platform which mitigates or eliminates the risk of a machine operating on the network from advertising itself as the default router and intercepting all network traffic.

### SUMMARY OF THE INVENTION

The present invention relates to a mobile, Internet protocol (IP) based network which provides a means for changing the default router on the network in the event of a failure of the default router. The present invention is further directed to a means for preventing a device accessing the network from advertising itself to a host as the default router and therefore intercepting all network traffic.

In one preferred embodiment the present invention implements the Internet Control Message Protocol (ICMP) Router Discovery Protocol (IRDP) on an IP-based network disposed on a mobile platform. The mobile platform may comprise an aircraft, a ship, a train or virtually any other form of vehicle having a plurality of occupants operating computing devices coupled to the network on the platform. With IRDP, each of the routers has a designated “preference” value which is included in advertisements which are transmitted by each router over the network to the host or hosts. The hosts select the router which is advertising the highest priority and uses that router as the default router. Each advertisement also carries a “time to live” value that will allow each host (or hosts) to time out an entry in its routing table if that router should fail and cease transmitting advertisements after its last transmitted advertisement expires. The host can then replace the entry of the failed router with a different router advertising the next highest preference value. This allows more than one router on the network to be configured as the default router in the event the initially configured default router should fail.

In the present invention, it is anticipated that one or more routing devices which may be directly coupled to passenger or occupant seats or stations will be included. For convenience, each one of these routing devices is referred to as a “seat electronics box” (SEB). Each SEB runs the host IRDP function. In one preferred embodiment, a plurality of servers each including a router are also interfaced to the network. In the event one server fails, IRDP allows one of the other servers having the next highest preference value to be configured for use as the default router on the network.

The present invention further implements a security safeguard to eliminate the possibility of a device interfaced to the network advertising itself as the default router and intercepting all network traffic from the host or hosts. This is accomplished by including a filter on each SEB interface which allows each SEB to accept only advertisements from specific servers and/or routers on the network. In one preferred form, the filters comprise packet filters which block all ICMP type 9 and type 10 packets transmitted to it from devices interfaced to the network.

The present invention thus makes use of the well known IRDP while allowing each of the SEBs on a mobile platform to reconfigure its routing tables to designate a new default router in the event a previously defined default router fails, which would prevent any network traffic from leaving the network. The present invention further implements a security safeguard for preventing “man-in-the middle” style attacks by a device interfaced with the network which advertises itself as the most preferred router.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a flowchart of an exemplary network suited for a mobile platform for use with the present invention; and

FIG. 2 is a flowchart illustrating the steps in removing a router which is failed as the default router and causing the host to designate a different router as the default router.

### DETAILED DESCRIPTION OF THE PREFERRED EMBODIMENTS

The following description of the preferred embodiment(s) is merely exemplary in nature and is in no way intended to limit the invention, its application, or uses.

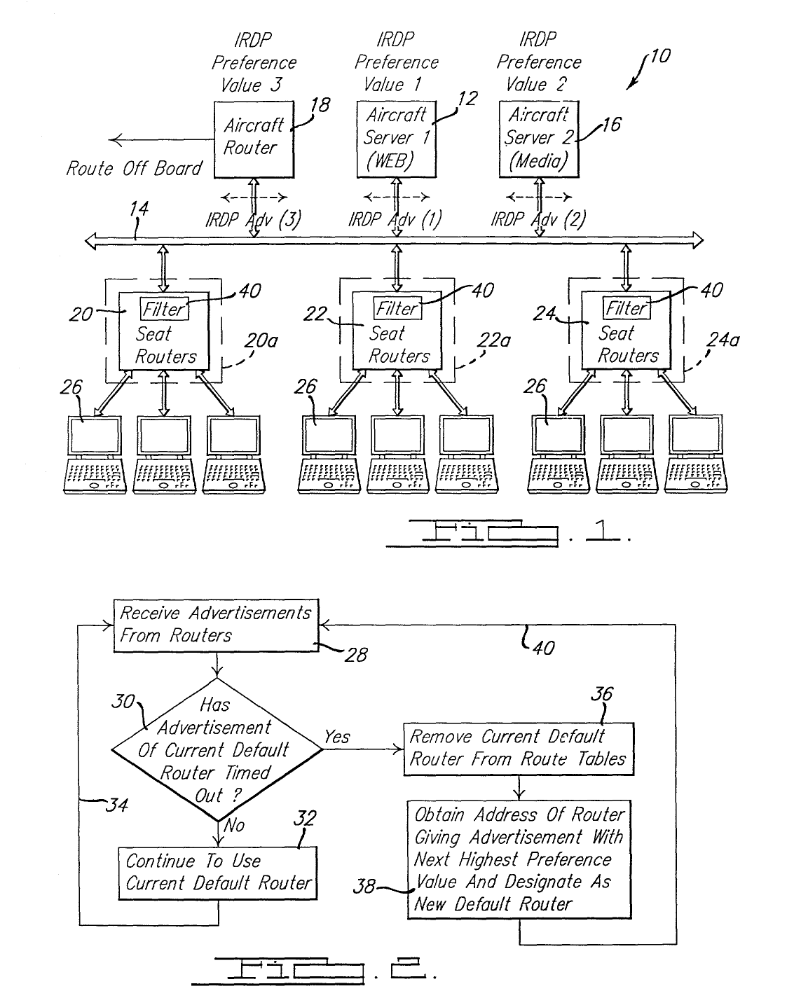

Referring to FIG. 1, a network 10 is shown as an example of a network configuration that may be implemented on a mobile platform, and with which the present invention may be used. The network 10 makes use of the Internet Control Message Protocol (ICMP) Router Discovery Protocol (IRDP). A first server is designated as “aircraft server 1” 12 which is interfaced to a communications bus 14 of the network 10. A second server designated “aircraft server 2” 16 is also interfaced to the communications bus 14. In one preferred form, the first aircraft server 12 comprises a web server which also includes a router. The second aircraft server 16 comprises a media server also including a router. The first aircraft server 12 is preferably used for storing Internet web pages. The media server is used for storing other forms of media (i.e., streaming audio and/or video) content which passengers or occupants on a vehicle such as an aircraft, ship or train may wish to view or listen to. An “aircraft router” 18 is also interfaced to the bus 14. The aircraft router 18 is used for routing network traffic off of the vehicle on which the network 10 is located. It will be appreciated that a lesser or greater number of routers could be interfaced to the network 10 if desired.

Referring further to FIG. 1, a plurality of additional routers 20, 22 and 24 are also interfaced to the communications bus 14 of the network 10. Each router 20, 22 and 24 in one preferred form comprises a portion of a “seat electronics box” (SEB) 20a, 22a and 24a, respectively. Each SEB 20, 22 and 24 is used to interface a plurality of computing devices such as laptop computers, personal digital assistants or other personal computing devices 26 to the network 10. Of course, it will also be appreciated that a greater or lesser number of routers 20, 22 and 24 could be included depending upon the overall number of computing devices 26 which may need to be interfaced to the network 10.

Each of the routers 12, 16, 18, 20, 22 and 24 operate in accordance with the IRDP. As such, each router 12, 16 and 18 is caused to send periodic “advertisements” to each of the seat routers 20, 22 and 24. Each of the seat routers 20, 22 and 24 function as a “host” device. Each advertisement includes the network address of the router 12, 16 or 18 as well as a “preference” value and a “time-to-live” value. The preference value is a numerical value which is assigned to the router when the network 10 is initially configured. The preference value is a signed 32-bit quantity that provides a designation of the priority of the router on the network 10. Each seat router 20, 22 and 24 will use the router advertising the highest preference value as its “default” router and will designate that particular router in its routing table as the default router. Each seat router 20, 22 and 24 routes IP packets which it receives from each of the computing devices 26 to the router which it has designated in its routing table as the default router.

The Lifetime value is included in the header of every IRDP advertisement transmitted by each of the routers 12, 16 and 18. This value assigns a lifetime to the advertisement transmitted by the router 12, 16 or 18. If the seat routers 20, 22 and 24 fail to receive an advertisement from the router which is presently recognized as the default router within this time-to-live value, then each of the seat routers 20, 22 and 24 interpret this condition as a sign that there has been a failure with the default router. In this event, each of the seat routers 20, 22 and 24 need to be able to reconfigure their routing tables so as to be able to transmit IP packets from their associated computing devices 26 to a different router on the network 10.

The above-described problem when the default router fails is addressed by the present invention by using the IRDP to enable each seat router 20, 22 and 24 to select the router 12, 16 or 18 having the next highest preference value as the default router. In the exemplary network 10 shown in FIG. 1, the aircraft router 18 has the highest preference value (i.e., 3) and is therefore recognized as the default router by each of the seat routers 20, 22 and 24. If this router should fail, then the second aircraft server 16, having a preference value of “2”, will be recognized by each of the seat routers 20, 22 and 24 as the default router. If aircraft router 18 and the router of the second aircraft server 16 should both fail, then the IRDP enables the first aircraft server 12 to be recognized as the default router by each of the seat routers 20, 22 and 24.

The above described method of reconfiguring the routing table of each of the seat routers 20, 22 and 24 is illustrated in FIG. 2. Each of the seat routers 20, 22 and 24 acting as hosts on the network 10 receive advertisements from router 18 and the routers of the first and second servers, 12 and 16, respectively, as indicated at step 28. Each of the seat routers 20, 22 and 24 determine if the advertisement of the current default router (aircraft router 18) has timed out, as indicated at step 30. If not, each of the seat routers 20, 22 and 24 continue to use the aircraft router 18 as the default router, as indicated at step 32, and further continue to receive advertisements, as indicated by loop 34. If the determination made at step 30 indicates that the advertisement from the current default router has timed out, meaning that a subsequent advertisement was not received within the time-to-live value of the previously received advertisement from the default router, then the seat routers 20, 22 and 24 remove the current default router (i.e., aircraft router 18) from their routing tables, as indicated at step 36. Each seat router 20, 22 and 24 then obtains the address of the router providing an advertisement with the next highest preference value (i.e., the router of the second aircraft server 16) and designates that particular router as the new default router, as indicated at step 38. Each of the seat routers 20, 22 and 24 then continue to receive advertisements from the remaining routers operating on the network, as indicated by loop 40.

The present invention further implements a security safeguard to prevent against a device interfaced to the network 10 from advertising itself as the most preferred (i.e., default) router to the seat routers 20, 22 and 24. This safeguard is implemented by including a packet filter on the interface of each SEB 20a, 22a and 24a. This filter is illustrated in simplified form in FIG. 1 by filter 40 associated with each SEB 20a, 22a and 24a. This filter blocks all ICMP Type 9 and Type 10 packets and allows each SEB 20a, 22a and 24a to accept only advertisements from predefined routers (i.e., routers having an address known to the host to be a router authorized to operate as such on the network 10) and/or media servers on the network 10. This eliminates the possibility of some device being interfaced to the network 10 and transmitting advertisements with a higher preference value than the current default router in an effort to make each SEB 20a, 22a and 24a recognize it as the default router.

The present invention therefore eliminates the need to manually configure a default route on each host (i.e., seat router 20, 22 and 24) in the event tht the current default router should fail, thus preventing any IP packets from being transmitted off of the network 10. The present invention further eliminates the possibility that a device interfaced to the network 10 is able to advertise itself as the most preferred router, and thus intercept IP packets transmitted by the seat routers 20a, 22a and 24a.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A method for re-configuring communications between a host, a first router and a second router on a network in the event of a failure of the first router, wherein the host, first router and second router are all operating on an Internet Control Message Protocol (ICMP) Router Discovery Protocol (IRDP), the method comprising the steps of:
designating said first router as a primary router by using said IRDP to assign said first router a first preference value which said first router includes in advertisements it sends out to said host on said network;
designating said second router as a backup router by using said IRDP to assign said second router a second preference value which said backup router includes in advertisements it sends out to said host on said network;
causing said host to transmit data over said network to said primary router subsequent to receiving an advertisement from said primary router; and
in the event said host does not receive an advertisement from said primary router within a predetermined time period, causing said host to recognize an advertisement from said backup router and to treat said backup router as a primary router, and to transmit data to said backup router, whereby said backup router routes said data received from said host over said network to a desired destination.

2. The method of claim 1, wherein:
a plurality of said backup routers are provided, each of said backup routers being in communication with said host on said network and each being assigned a preference value; and
further comprising the step of said host using said backup router that has the highest preference value when said primary router fails.

3. The method of claim 1, further comprising the step blocking the reception of Type 9 and Type 10 ICMP packets transmitted on said network to said host by any router operating on said network.

4. The method of claim 1, further comprising the step of configuring said primary router to receive data packets from a plurality of independent computing devices.

5. A method for re-configuring communications between a host and a plurality of routers communicating sending advertisements to said host on said network, wherein said routers and said host are all operating on an Internet Control Message Protocol (ICMP) router discovery protocol (IRDP), the method comprising the steps of:
configuring said host for communication with a plurality of personal computing devices;
causing said host to recognize a first one of said routers which transmits an advertisement which includes an address having the highest preference value of all of said routers as a default router;
in the event said default router ceases transmitting advertisements on said network for a given period of time, causing said host to remove said first one of said routers as said default router from a routing table maintained by said host;
causing said host to recognize said router having the next highest preference value in its advertisement, as a secondary default router, and designating said secondary default router as a new default router in said routing table of said host; and
in the event said secondary default router ceases transmitting advertisements for a given period of time while said first one of said routers has also ceased transmitting advertisements, then causing said host to recognize said router transmitting advertisements having the next highest preference value to that of the secondary router as a tertiary router, and designating said tertiary router as said default router in said routing table of said host.

6. The method of claim 5, further comprising the step of using at least one packet filter with said host to allow said host to accept only advertisements transmitted on said network of predetermined routers known to be operating on said network.

7. The method of claim 6, wherein the step of using at least one packet filter comprises the step of blocking the receipt by said host of any advertisement transmitted to it on said network which comprises one of a Type 9 and a Type 10 packet to insure against the diversion of data packets transmitted from said host to an authorized router transmitting advertisements on said network.

8. A method for re-configuring communications between a host and a plurality of routers communicating sending advertisements to said host on said network, wherein said routers and said host are all operating on an Internet Control Message Protocol (ICMP) Router Discovery Protocol (IRDP), the method comprising the steps of:
configuring said host for communication with a plurality of personal computing devices;
causing said host to recognize a first one of said routers which transmits an advertisement which includes an address having the highest preference value of all of said routers as a default router;
in the event said default router ceases transmitting advertisements on said network for a given period of time, causing said host to remove said first one of said routers as said default router from a routing table maintained by said host;
causing said host to recognize said router having the next highest preference value in its advertisement, as a secondary default router, and designating said secondary default router as a new default router in said routing table of said host; and
in the event said secondary default router ceases transmitting advertisements for a given period of time while said first one of said routers has also ceased transmitting advertisements, then causing said host to recognize said router transmitting advertisements having the next highest preference value to that of the secondary router as a tertiary router, and designating said tertiary router as said default router in said routing table of said host; and
using at least one packet filter on said host to restrict the advertisements said host can receive on said network.

9. The method of claim 8, wherein the step of using at least one packet filter comprises the step of blocking the reception by said host of all Type 9 data packets transmitted to it on said network.

10. The method of claim 8, wherein the step of using at least one packet filter comprises the step of blocking the reception by said host of all Type 10 data packets transmitted to it by said network.

11. A method for re-configuring communications between a host, a first router and a second router on a network in the event of a failure of the first router, wherein the host, first router and second router are all operating on an Internet Control Message Protocol (ICMP) Router Discovery Protocol (IRDP), the method comprising the steps of:
designating said first router as a primary router by using said IRDP to assign said first router a first preference value which said first router includes in advertisements it sends out to said host on said network;
designating said second router as a backup router by using said IRDP to assign said second router a second preference value which said backup router includes in advertisements it sends out to said host on said network, said second preference value being less than said first preference value;
causing said host to transmit data packets on said network to said primary router subsequent to receiving an advertisement from said primary router;
in the event said host does not receive an advertisement from said primary router within a predetermined time period, causing said host to recognize an advertisement from said backup router and to treat said backup router as a primary router, and subsequently transmit data to said backup router in lieu of said first router, whereby said backup router routes said data received from said host over said network to a desired destination; and
using a filter on said host to restrict the types of advertisements said host may receive to thereby eliminate the possibility of an unauthorized router that has gained access to said network transmitting advertisements that cause said host to recognize said unauthorized router as said default router.

12. The method of claim 11, wherein the step of using a filter comprises blocking all Type 9 advertisement packets transmitted on said network.

13. The method of claim 11, wherein the step of using a filter comprises blocking all Type 10 advertisement packets transmitted on said network.
